(19) United States
(12) Patent Application Publication
(10) Pub. No.: US 2004/0023560 A1
(43) Pub. Date: Feb. 5, 2004

(54) Apparatus and method for a reversible emulator/target cable connector

(76) Inventor: Gary L. Swoboda, Sugar Land, TX (US)

Correspondence Address: TEXAS INSTRUMENTS INCORPORATED, P O BOX 655474, M/S 3999, DALLAS, TX, 75265

(21) Appl. No.: 10/212,550

(22) Filed: Aug. 5, 2002

(51) Int. Cl. H01R 25/00

(52) U.S. Cl. 439/638

(57) ABSTRACT

A cable with a cable connector on either end is described wherein the cable connectors can have a normal relative orientation or can have a 180 relative orientation. Apparatus associated with one of the cable connectors can determine the relative orientation of the two cable connectors. The determination of the orientation can be used to apply the correct signals to the components of the apparatus regardless of the relative orientation.

### BACKGROUND OF THE INVENTION

1. Field of the Invention

This invention relates generally to the testing of digital signal processing units and, more particularly, to exchange of data between a target digital signal processing unit under test and the emulator unit receiving the test signals. The connector between the emulator unit and the target processing unit must accurately transmit a multiplicity of signals.

2. Background of the Invention

In the test and debug of a digital signal (target) processing unit by an emulator unit, a large number of signals must be typically exchanged between the two components. The connector by which the signals are exchanged therefore must include a large number of conductors. It is imperative that correct internal signal of the target processing unit be coupled to the correct internal circuits of the emulator unit through the cable, and therefore the cable connectors electrically coupling the two units.

Most cable connectors have a generally rectangular shape. Therefore, the cable connector has two possible orientations with respect to a mating receptor. In the prior art, the cable connector and the mating receptor have a structure that permits the cable connect and the mating receptor to be engaged in only one orientation. None-the-less, experience has shown that frequently an attempt is made to force the cable connector and the mating receptor together in the incorrect orientation. Furthermore, certain orientations can result in interference problems with other components. This attempted at forced connection can result in structural damage to either the cable connector or the mating receptor. Or, in a particular orientation, the connector cannot be plugged in at all. Sufficient force can cause also cause the cable connector and the mating receptor to be electrically coupled with wrong orientation, thereby introducing incorrect signals into the circuits of the emulator unit. It is a more particular feature of the present invention to provide the two cable connectors each with two terminals, the two terminals exchanging positions upon 180° rotation of the cable connectors, the two terminals of each cable connector being coupled to the two terminals of the other cable connector.

A need has therefore been felt for apparatus and associated method having the feature that a cable is provided for correct electrical coupling of a target processing unit and an emulator unit. It is another feature of the apparatus and associated method that the connectors at either end of the cable can engage mating receptors without regard to orientation. It is a still further feature of the present invention that specific connector terminals are used to determine the relative orientation of the two cable connectors. It is a still further feature of the present invention to permit the emulator unit to correctly account for the relative orientation of the cable connectors when the cable connectors are coupled to the mating receptors.

### SUMMARY OF THE INVENTION

The aforementioned and other features are accomplished, according to the present invention, by providing connectors at each end of a cable, each cable connector having two preselected terminals. The preselected terminals exchange position when the cable connectors are rotated by 180°, i.e., the preselected terminals are symmetric with respect to the cable connector position upon 180° rotation. The mating receptors to which the cable connectors are coupled can engage the cable connectors either in the correct orientation or in an orientation wherein the associated cable connector is rotated 180° with respect to the mating receptor. Each of the two preselected terminals of one cable connector is coupled to one of the preselected terminals of the second cable connector. A difference in the electrical characteristics of the two preselected terminals is established for the connector at one end of the cable. Then, one of the preselected terminals of the cable connector at the second end of the cable is measured. This measurement determines whether the cable connector at the first end of the cable has same orientation as the cable connector at the second end of the cable, or the two cable connectors have a relative rotation of 180°. Because the relative orientation of the two cable connectors can be determined, this determination can be used to control the position of a switch that insures the electrical signals from the cable connector are applied to the appropriate conductors in the emulator unit.

Other features and advantages of present invention will be more clearly understood upon reading of the following description and the accompanying drawings and the claims.

### BRIEF DESCRIPTION OF THE DRAWINGS

FIG. 1A is a end view of a cable connector that couples to an emulator unit, FIG. 1B is an end view of a cable connector that couples to a target processing unit, and FIG. 1C illustrates the relationship between the two connectors according to the present invention.

FIG. 2 illustrates exemplary labeling for the pins of cable connector 20 and the conductors coupled thereto.

FIG. 3 illustrates the labeling of the conductors coupled to the pins of connector 20 for the normal orientation of the second cable connector and for the relative rotation of the cable connector of 180°.

### DETAILED DESCRIPTION OF THE FIGURES

1. Detailed Description of the Figures

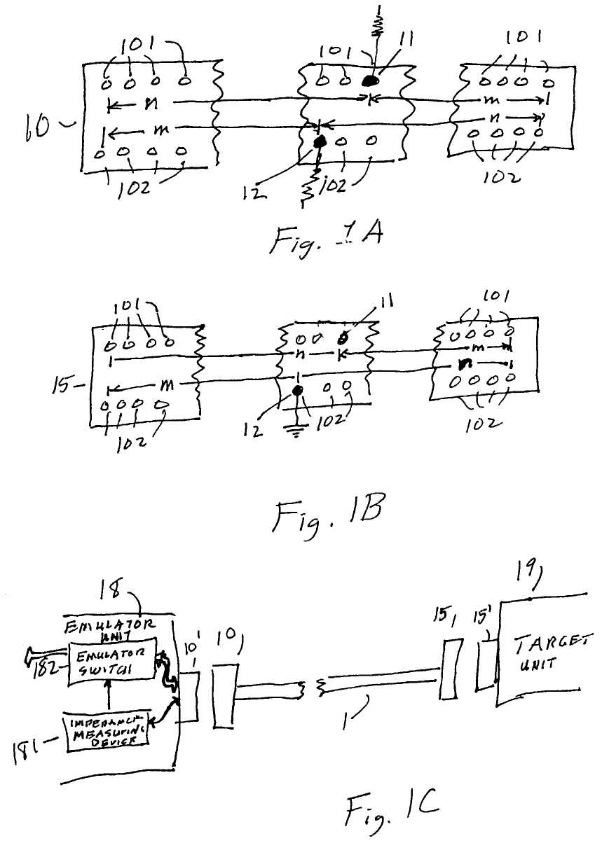

Referring to FIG. 1A, an end view of a cable connector 10 at a first end of a cable suitable for coupling to an emulator unit is shown. The cable connector has at least two rows of pins 101 and 102, each row having m+n pins. The row of pins 101 has a designated pin 11 positioned as the nth pins from a first side and as the mth pin from the second side. The row of pins 102 has a designated pin 12 positioned as the mth pin from the first side and as the nth pin from the second side. As will be clear by reference to FIG. 1A, the cable connector can be rotated 180° and the pins 11 and 12 will be exchanged. Also shown in FIG. 1A are impedances coupled to terminals 11 and 12. These impedances would typically be in the emulator unit itself.

Referring to FIG. 1B, an end view of the cable connector 15 at the second end of the cable, coupled to the target processing unit, is shown. As with cable connector 10, the cable connector 15 has a first row of m+n pins 101 and a second row of m+n pins 102. In the first row, pin 11 is the nth pin from a first side of cable connector and the mth pin from the second side of cable connector 15. Pin 12 in the second row is the mth pin from the first side of the cable connector 15 and the nth pin from the second side of cable connector 15. As with cable connector 10, when cable connector 15 is rotated by 180°, pin 11 and pin 12 are interchanged. Pin 12 is shown as being grounded while pin 11 is shown as being open-circuited. The coupling on the impedances to pins 11 and 12 would typically be provided in the target processing unit. In the preferred embodiment, terminal 11 of cable connector 10 is electrically coupled to terminal 11 of cable connector 15 and terminal 12 of cable connector 10 is electrically coupled to terminal 12 of cable connector 15.

As shown in FIG. 1C, cable connector 10 is coupled by cable 1 to cable connector 15. The corresponding pins, 11 and 12 in the two cable connectors 10 and 15, are electrically coupled by two of the conductors forming cable 1. In operation, the cable connector 10 is coupled to a mating receptor 10′ in the emulator unit 18, while the cable connector 15 is coupled to a mating receptor 15′ coupled to the target unit 19. In the target unit 19, the pin 12 is grounded while the pin 11 is uncoupled, i.e., is a high impedance. In the emulator unit 18, an impedance measuring device 181 is coupled to a pin that corresponds to pin 12 at the target unit 19. The impedance measuring device 181 will measure a low impedance as the result of grounding of pin 12 at the target unit 19. However, when the cable connector 15 is rotated by 180° with respect to the cable connector 10, pin 12 at the emulator unit 18 is actually coupled to pin 11 of the target unit 19. As indicated above, pin 11 is open-circuited and therefore a high impedance will be measured by the impedance measuring device 181 rather than the low (short-circuited) impedance. Therefore, the measurement of the impedance provides a determination as to whether the cable connectors have the same orientation when coupled to the emulator unit and the target unit, or are rotated by 180°. An emulator switch 182 is placed between the mating connector of emulator unit 18 and the test components of the emulator unit 18. Thus, when a low impedance is measured, emulator switch causes the signals for the normal relative orientation to be applied to the test circuits of the emulator unit 18. When a high impedance in measured by the impedance measuring device 181, the resulting signal from device 181 causes the emulator switch to apply signals from a complementary set of terminals to the test circuits of emulator 18.

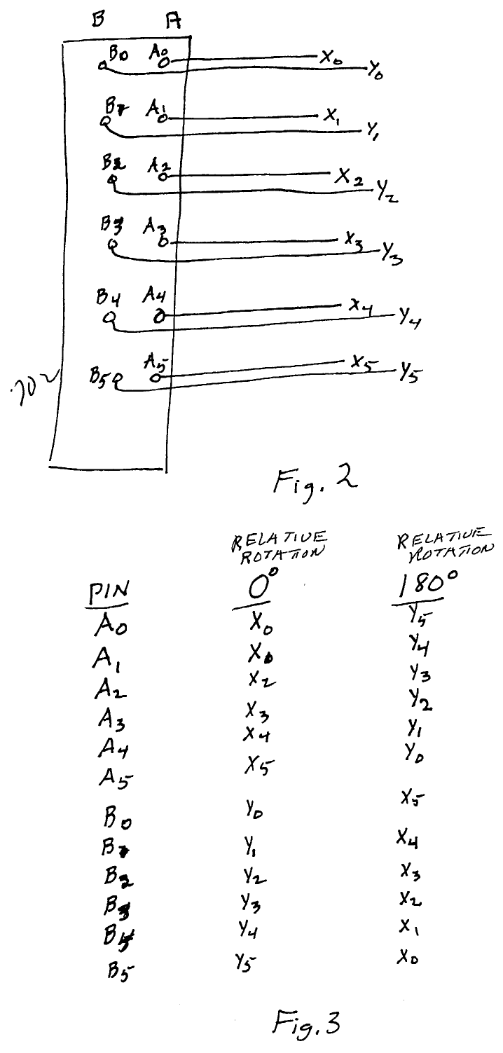

Referring to FIG. 2, the cable connector 20 has two rows of pins, row A having pins A₀ through A₅ and row B having pins B₀ through B₅. Coupled to pins A₀ through A₅ are conductors x₀ through x₅, respectively. Coupled to pins B₀ through B₅ are conductors y₀ through y₅, respectively. The labels of the conductors can be associated with the pins to which they are connected in the second cable connector.

Based on FIG. 2, the complementary signals discussed with respect to FIG. 1C can now be illustrated. Referring to FIG. 3, a table of the coupling of the conductors to the cable connector 20 as a result of the relative orientation of the two cable connectors is shown. In the first column of FIG. 3 are the labels of the pins shown in FIG. 2. Similarly, the column 0° illustrates the conductors coupling the cable connector 20 when the two cable connectors have the same orientation. In the column labeled 180°, the coupling of the connectors when the cable connector not shown in FIG. 2 is rotated 180° with respect to cable connector 20. Of particular interest is that conductor coupling has a definite set of signals in either orientation. Thus a multi-terminal emulator switch 182 can be coupled to pins of the cable connector, the position of the switch (i.e., the transmitted set of signals) being determined by the output of the impedance measuring device 181.

2. Operation of the Preferred Embodiment

While the foregoing description of cable connectors has been given in terms of two rows of pins for each cable connector, it will be clear that the only requirements of the pins is that the pins be capable of engaging the mating receptor in either the normal orientation or in the rotated orientation. In addition the designated pins (e.g., pins 11 and pins 12 in FIG. 1A and FIG. 1B) engage the same pin of the mating connector in the normal orientation and, in the rotated orientation, pins 11 of both cable connectors are coupled to pins 12 of the other cable connector.

The invention has been described wherein the emulator unit determines the orientation of the target unit. As will be clear, the apparatus for detecting the relative orientation of the two cable connectors can be located in either of the two devices. Similarly, the switch unit that corrects for a mis-oriented cable connector can be located in either of the two devices.

It will also be clear that the impedances illustrated in FIG. 1B can be formed as part of the connector/cable itself. In this embodiment, an impedance measuring device will be included in both the emulator unit and the target unit. It will also be clear that the present invention can be used with any pairs of devices that are coupled by a detachable cable.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A cable for coupling two electronic devices, the cable comprising:
a first cable connector;
a second cable connector, the first cable connector and the second cable connector having the same pin configuration upon 180° rotation; and
a plurality of conductors coupling similarly-located pins on both the first and the second cable connectors when the cable connectors are similarly oriented;
wherein a designated first pin and a designated and second pin on each cable connector exchange positions upon 180 rotation of the cable connectors.

2. The cable connector as recited in claim 1 wherein the first and the second designated pins have the same position on the first and the second cable connector.

3. The cable as recited in claim 1 wherein when a know impedance is applied to a first pin of the first cable connector, the impedance across one of the first and second pins of second cable connector determine the relative orientation of the first and the second cable connectors.

4. A method for identifying the relative orientation of cable connectors of a cable, the method comprising:
fabricating the cable connectors to couple to mating receptors with a normal orientation and with a rotation of 180°;
selecting two selected terminals for each cable connector, the two selected terminals exchanging locations with respect to terminals of a mating receptor when the connectors are rotated by 180°, each of the two selected cable of the first cable connector being coupled to a different one of the two selected cables of the second cable connector;
applying a known impedance to one the selected terminals of the first cable connector; and
measuring the impedance at one of the selected terminals of the second cable connector.

5. The method as recited in claim 4 wherein the measuring step determines the relative orientation of the first and the second cable connector.

6. A system for detachably, electrically coupling a devices, the system comprising:
a first device with a first mating receptor,
a second device with a second mating receptor; and
a cable, the cable including;
a plurality of cable conductors;
a first cable connector coupled to the cable conductors, the first cable connector detachably coupled to the first mating receptor, the first cable connector having two preselected terminals, the two preselected terminals exchanging positions with terminals of the first mating receptor upon 180° rotation of the first cable connector with respect to the first mating connector; and
a second cable connector coupled to cable conductor, the second cable connector detachably coupled to the second mating receptor, the second cable connector having two preselected terminals, the two preselected terminals of the second cable connector exchanging positions with terminals of the second mating receptor upon 180° rotation of the second cable connector with respect to the second mating receptor, wherein each preselected terminal of the first cable connector is coupled to a one of the preselected terminals of the second cable connector.

7. The system as recited in claim 6 further comprising predetermined impedance in the first device coupled to a selected one of the preselected terminals.

8. The system as recited in claim 7 wherein the second device includes an impedance measuring device coupled to at least one of the preselected terminals.

9. The system as recited in claim 8 wherein the second device includes a switch responsive to a signal from the impedance measuring device, the switch applying signals to internal circuits of the second device determined by the relative orientation of the first and second cable connects.

10. The system as recited in claim 9 wherein the first device is target unit and the second device is an emulator unit.
